(19) United States
(12) Patent Application Publication
(10) Pub. No.: US 2010/0074336 A1
(43) Pub. Date: Mar. 25, 2010

(54) Fractional motion estimation engine

(76) Inventors: Mina Goor, Chandler, AZ (US); Joseph Warner, Tempe, AZ (US)

Correspondence Address: TROP, PRUNER & HU, P.C., 1616 S. VOSS RD., SUITE 750, HOUSTON, TX, 77057-2631, US

(21) Appl. No.: 12/284,783

(22) Filed: Sep. 25, 2008

(51) Int. Cl. H04N 7/12; H04N 11/02

(52) U.S. Cl. 375/240.16; 375/240.24; 375/E07.123

(57) ABSTRACT

Fractional motion estimation may be implemented by tagging sub-blocks of a first size. The sub-blocks may be located within blocks of picture data of a variety of different sizes, including the first size. The sub-blocks are tagged to link them to their motion vectors so that more efficient calculations may be implemented in some embodiments.

### BACKGROUND

This relates generally to graphics processing in processor-based devices and, in particular, to motion estimation.

In order to reduce the size of images to be transferred between processor-based devices, such as computers and cell phones, it is desirable to reduce the amount of information that is conveyed in order to present the image. Video compression is used to accomplish the reduction of information. In order to perform video compression, motion estimation is utilized. Motion estimation involves analyzing previous or future image frames to identify image blocks within a frame that have not changed or have only changed in location. Motion vectors are then compactly stored in place of those blocks.

Generally, motion estimation involves breaking down an image or frame into portions. Then, processing on some portions may not need to be repeated for other portions, such as neighboring portions with similar motion. In some cases, portion sizes can also change from frame to frame.

Using larger portions for motion estimation reduces the amount of information needed to represent the image. However, using smaller portions may result in better resolution. Thus, there is a tradeoff between efficiency or cost and resolution when choosing the sizes of the portions of the image to be analyzed. Generally, motion estimation involves trying a different mix of portion sizes, and analyzing the processing costs to handle those block sizes and the resulting resolution.

There are a number of different video compression algorithms. The H.264 algorithm was provided by the International Telecommunication Union, and a Telecommunication Standard Sector (ITU-T) recommendation H.264 titled “Advanced Video Coding for Generic Audiovisual Services,” (2004). However, there are many other widely used encoding algorithms as well.

### BRIEF DESCRIPTION OF THE DRAWINGS

FIG. 1 is a block diagram for one embodiment of the present invention; and

FIG. 2 is a processor-based system in accordance with one embodiment of the present invention.

### DETAILED DESCRIPTION

In fractional motion estimation, instead of locating the best matching blocks with a resolution of one pixel, resolutions of half and/or quarter pixel may be utilized. Generally, fractional motion estimation involves the use of interpolation between existing pels to determine if half pixel or quarter pixel resolution may be preferable.

In contrast, in integer motion estimation, only the existing pels are utilized. For example, in H.264 integer motion estimation, error values may be calculated for 4×4 sub-blocks and then assembled into the forty-one possible block error values. It is well known for each microblock how the 4×4 sub-blocks are related to each other.

However, in fractional motion estimation, there is no way to determine if there is any overlap between the best forty-one possible block error values derived from the integer search.

In some motion estimation algorithms, such as the H.264 algorithm, a 16×16 macroblock of picture elements is utilized. The macroblock may be made up of seven different block sizes: 16×16, 4×4, 4×8, 8×4, 16×8, 8×16, and 8×8. There are forty-one possible motion vectors for such a 16×16 macroblock, some of which are overlapping and redundant. Thus, there are sixteen motion vectors for 4×4 blocks, four for 8×8 blocks, one for the 16×16 block as a whole, two for 16×8 blocks, two for 8×16 blocks, eight for 4×8 blocks, and eight for 8×4 blocks. In fact, the 16×16 block may be broken up in 1600 ways with seven block sizes.

Fractional motion estimation assumes at least one additional pixel between two known picture elements. In some cases, it may improve the picture resolution without an undue cost in terms of efficiency of the calculation algorithm. The forty-one motion vectors correspond to both overlapping and non-overlapping sub-blocks. The biggest of the sub-blocks being 16×16 and the smallest being 4×4 in one embodiment. In some embodiments, a minimum sub-block size, such as 4×4, may be adopted. A picture is broken into sub-blocks smaller than that given size, such as 4×4 or 8×8, as two examples.

In some embodiments, variable block size motion vectors may be used. In such embodiments, the forty-one motion vectors may be assigned to blocks of the given size, such as 4×4 size. Then, if each 4×4 sub-block is tagged with which one of the forty-one motion vectors it belongs to, the blocks may be linked to the motion vectors during fractional motion estimation. Because of the overlap between the component 4×4 sub-blocks, the processing load may be greatly reduced in some cases.

While an embodiment is described using a 16×16 macroblock and 41 motion vectors, other macroblock sizes may also be used. In addition, different numbers of motion vectors may be used.

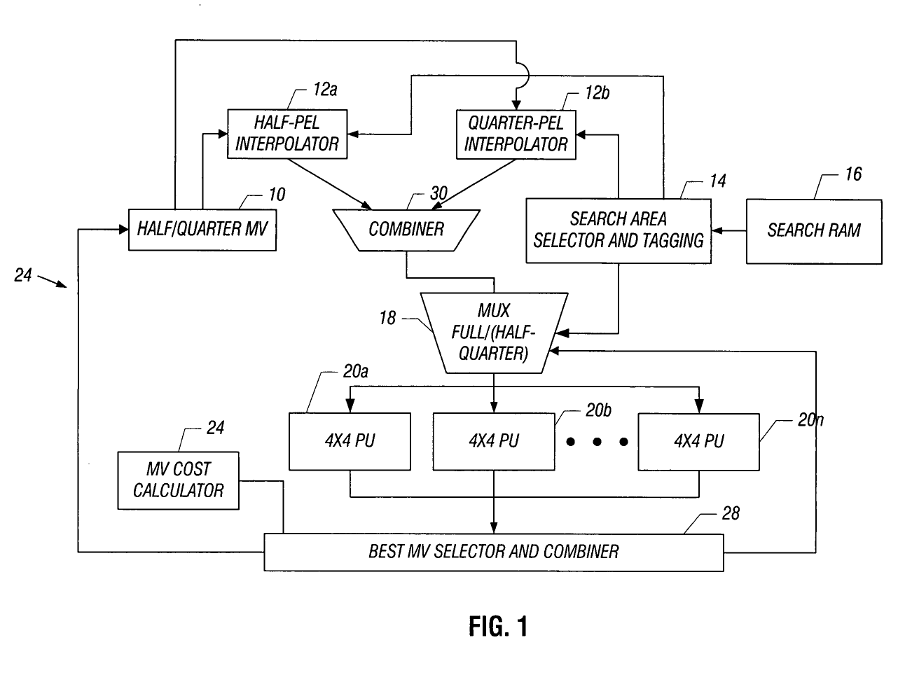

Thus, referring to FIG. 1, processing units (PU) 20 may, in one embodiment, analyze seven sub-blocks. The processing units 20, which may also be called accumulators, add an error value for each sub-block to get the total error values for an entire block of sub-blocks. The processing units 20 may be controllers or processors such as multi-core processors, as examples. In an embodiment with 4×4 sub-blocks, there are sixteen processing units 20. Each processing unit 20 may calculate an error value between reference and current frames. Techniques for calculating such error values are well known and include the use of the sum of absolute differences (SAD).

Then, the total error for each 4×4 sub-block is calculated from the component errors in each processing unit 20. This may be done for each of the nine positions for a half pel interpolation. The nine positions are made up of the eight positions between a given pel and its eight immediate neighbors, as well as the pel itself.

Then, the best motion vector combination is chosen in the selector and combiner 28. The best motion vector combination is chosen based on the best tradeoff between resolution and processing cost. The processing cost may be calculated in the motion vector cost calculation unit 26. The cost is determined by the cycle time consumed to perform the interpolation needed to achieve better resolution. If the cost is too high for the amount of resolution improvement, the best motion vector selector 28 may select a less computationally complex size.

The results of the motion vector selector and combiner 28, if acceptable, are then fed to a controller 24. The controller 24 starts the same processing cycle, but at the quarter pel accuracy for the best half pel positions. Thus, the output from the selector and combiner 28 may be provided to a half/quarter motion vector unit 10.

The motion vector unit 10 operates on motion vectors at either the half pixel resolution or the quarter pixel resolution, depending on the stage in the controller 24 cycle. For example, in the first pass through the controller 24, half pixel resolution may be utilized and, if needed, in the next pass, quarter pixel resolution will be provided.

The half or quarter pixel motion vectors are then fed to the interpolators 12a and 12b. In the case of a half pixel interpolation, the half pixel interpolator 12a is utilized and, otherwise, in the case of a quarter pixel interpolation, the interpolator 12b is utilized. In some cases, it may be possible to combine the two interpolators into a single interpolator that does both the half and quarter pixel interpolations. In some cases, the calculations from the half pixel interpolation may be reused to simplify the interpolation at the quarter pixel resolution.

In one embodiment, half pixel interpolation may use a 7-tap finite impulse response (FIR) filter. The half pixel samples are then used to compute greater pixel samples by averaging two adjacent samples horizontally, vertically, or diagonally.

The data that is provided to the interpolators 12a or 12b is selected, by the search area selector and tagging 14, from a search random access memory (RAM) 16. Rather than process the entire picture at one time, segments of the picture, stored in the search RAM 16, may be selected by the selector and tagging 14 in serial fashion to break up the calculation into reasonably sized chunks.

The search area selector and tagging 14 also provides tagging that links each given maximum sized sub-block, such as the 4×4 block, with its motion vector. This may be done, in some embodiments, by using a grid system to assign addresses to sub-blocks. For example, the grid system may have rows and columns that can be used to specify a pixel position. A given sub-block may be identified by a pixel in a predetermined position, such as the upper left corner of the sub-block. In this way, the sub-blocks may be correlated to their related motion vectors.

Thus, even if the sub-block is a part of a number of larger blocks, all associated with different motion vectors, the values calculated for the given sub-block, such as the 4×4 sub-block, may be reused in those calculations, simplifying the calculations. In fractional motion estimation, this is all possible because of the tagging that enables those sub-blocks to be linked to motion vectors.

Tagging may be implemented in many different ways. As a first example, each block (4×4, for example) may have a 41 bit register. When a bit is set, the corresponding processing unit 20 would add the value. As another example, each block may be assigned a random number and the random number is sent to the processing units 20. The processing units compare the random number of the block with the random numbers in their queue. If it is present, the value is added. A different approach is to have a queue for each processing unit 20 with the numbers not to add. As still another example, there may be ports for each processing unit. When an assert signal is sent to these ports, the processing unit adds the value, according to an assertion pattern.

Either the half pixel or quarter pixel interpolation is then selected by the multiplexer or combiner 30 and fed to the multiplexer 18. The multiplexer 18 enables selection of either full, half, or quarter pixel resolutions.

The multiplexer 18, under control of the combiner 28, then feeds the data into successive processing units 20. For example, in one embodiment, the blocks may be broken up into 4×4 sub-blocks that are tagged to motion vectors by the search area selector and tagging 14 and then fed into the next available processing unit 20. In some embodiments, the tagging may be done during the integer interpolation search and then preserved for subsequent use in the half and/or quarter pixel resolution searches.

Thus, in some embodiments, the system can progress from integer motion estimation to half pixel motion estimation and then to quarter pixel motion estimation, finding the best tradeoff between cost and resolution. Each interpolator 12a and 12b may use a well known interpolation formula. The apparatus shown in FIG. 1 can do both half, quarter, and full interpolation using the same or different filters in one embodiment.

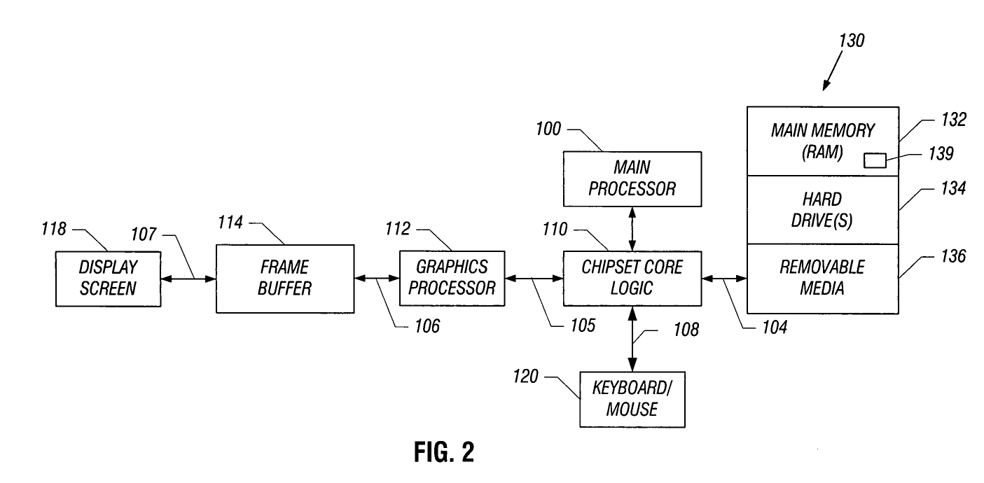

Referring to FIG. 2, the motion estimation implemented by the apparatus of FIG. 1 may be incorporated into any apparatus that does video processing, coding, or compression. Many media devices use such motion estimation. The motion estimation may be implemented in graphics processing chipsets, set top box chipsets, or graphics processor, to mention a few examples.

Referring to FIG. 2, a typical graphics pipeline provides rendered graphics from a graphics processor 112 over a link 106 to a frame buffer 114 for display via link 107 on a display screen 118. The graphics processor 112 may be coupled by a bus 105, such as a Peripheral Component Interconnect (PCI) bus, to a chipset core logic 110. The graphics processor 112 may be a multicore processor. The core logic 110 is coupled to a main processor or central processing unit (CPU) 100. The central processing unit may be one or more processors that handle a variety of processing functions of a computer system, while the graphics processor is dedicated to graphics functions. The core logic may also be coupled to removable medium 136, hard drives 134, and main memory 132, which may store a program 139. The core logic 110 may be coupled by a link 108 to a keyboard or mouse 120 for control of the display. The program 139 may be made up of instructions that are executed by the processor 100 or the processor 112. Thus, the main memory 132 constitutes one example of a computer readable medium that may store executable instructions in accordance with some embodiments of the present invention.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multi-core processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
performing fractional motion estimation on blocks of pixel data having a plurality of different sizes, including a plurality of sizes larger than a first size;
breaking up said blocks into sub-blocks of said first size; and
tagging each of said sub-blocks with a motion vector.

2. The method of claim 1 wherein performing motion estimation includes comparing the resolution improvement with a given block size to the processing cost incurred in achieving that block size.

3. The method of claim 1 including using variable block size motion vectors.

4. The method of claim 1 including providing selectable full, half, and quarter pixel motion estimation.

5. The method of claim 1 including breaking up data into sub-blocks of said first size and processing each of said sub-blocks in a separate processing unit.

6. The method of claim 1 including interpolating only part of the picture at one time.

7. The method of claim 1 including providing said tagging during integer motion estimation.

8. The method of claim 1 including selectively providing integer, half, and quarter pixel interpolation and determining which interpolation provides the best tradeoff of cost and resolution.

9. The method of claim 1 including tagging by identifying an address of each sub-block.

10. The method of claim 9 including tagging by identifying a uniquely oriented corner of each sub-block.

11. An apparatus comprising:
a controller to perform fractional motion estimation on blocks of pixel data having a plurality of different sizes, including a plurality of sizes larger than a first size;
a device to break up blocks into sub-blocks of said first block size; and
a tagging unit to tag each of said sub-blocks with a motion vector.

12. The apparatus of claim 11 including a separate processing unit for each of said sub-blocks.

13. The apparatus of claim 11 including a combiner to select the best motion vector based on resolution and cost.

14. The apparatus of claim 11 including a multiplexer to select full, half, or quarter pixel motion estimation.

15. The apparatus of claim 11 wherein said controller is a variable block size motion vector motion estimation controller.

16. The apparatus of claim 15 including a half pel and a quarter pel interpolator.

17. The apparatus of claim 11 including a multiplexer to selectively feed sub-blocks of data to processing units.

18. The apparatus of claim 11 including a search area selector to select an area of a picture on which to perform motion estimation.

19. The apparatus of claim 11 wherein said first size is a 4×4 sub-block.

20. The apparatus of claim 11 wherein said controller is a multi-core processor.
